(19) United States
(12) Patent Application Publication
(10) Pub. No.: US 2018/0121621 A1
(43) Pub. Date: May 3, 2018

(54) PROVIDING CUSTOMIZED CONSUMER DISCOUNTS ON PRESCRIPTION MEDICATIONS

(71) Applicant: Joseph Lee Wiley, II, West Monroe, LA (US)

(72) Inventor: Joseph Lee Wiley, II, West Monroe, LA (US)

(21) Appl. No.: 15/799,321

(22) Filed: Oct. 31, 2017

Related U.S. Application Data
(60) Provisional application No. 62/414,979, filed on Oct. 31, 2016.

(51) Int. Cl. G06F 19/00; G06Q 30/02

(52) U.S. Cl. CPC G06F 19/328; G06Q 30/0239

(57) ABSTRACT

A computer-implemented method of providing a discount to a consumer purchasing a medication from a pharmacy includes receiving, by a discount payer adjudication engine, a new benefit claim from a pharmacy computer comprising (i) a member identifier corresponding to a member and (ii) an indication of medication. The discount payer adjudication engine determines whether the member is eligible for the new benefit claim at least in part based on one or more previously approved benefit claims associated with the member. If the member is eligible for the new benefit claim, an approved claim response is transmitted to the pharmacy computer. If the member is not eligible for the new benefit claim, a denied claim response is transmitted to the pharmacy computer.

### PRIORITY CLAIM

This application claims the benefit of U.S. Provisional Patent Application Ser. No. 62/414,979, filed on Oct. 31, 2016, the entire contents of which are hereby incorporated by reference herein.

### TECHNICAL FIELD

The present invention relates generally to computer-based methods, systems, and apparatuses for the providing of consumer discounts for prescription drugs and medications, whether they be prepared commercially or compounded at a pharmacy.

### BACKGROUND

With the increasing cost of drugs, consumers as a whole are a highly price-sensitive group. Indeed, studies have shown that the likelihood of a consumer purchasing drugs is strongly correlated with the consumer's out-of-pocket amount for the drugs. As an example, consumers may select one drug over another based upon a lower co-pay amount. As another example, a consumer may select (or request a prescription for) a drug that is covered by one or more third-party payers (e.g., an insurance plan) as opposed to a drug that is not covered by the third-party payers.

Given that consumers are a price-sensitive group; it is not unusual to expect that consumers may refuse to purchase a drug, stop taking a drug, or switch to a cheaper drug if the consumer's out-of-pocket amount is higher than the consumer's perceived value of the drug. The consumer's out-of-pocket amount may be unacceptable, for example, where the employer changes the co-payment required for a drug that is covered under its insurance plan, when the employer no longer provides benefit coverage for a drug that is required by the employee/consumer, or when the consumer has to choose between the medication and some other item that is needed in day-to-day life. Likewise, a consumer's out-of-pocket amount may increase where an insurer or other third-party payer changes the benefits sponsor(s) and/or drugs that are preferred. In these situations, the benefits sponsor(s) may lose control over the consumer's out-of-pocket amount for its drugs, thereby risking that the consumer will stop purchasing its drug products. Attempts have been made to provide a consumer with a discount for a specific drug. For example, U.S. Pat. No. 8,050,943 entitled “Systems and Methods for Retaining or Shifting Prescription Market Share,” the content of which is hereby incorporated by reference in its entirety, is directed to providing a consumer with a manufacturer discount for a specific drug, thereby shifting market share to a specific manufacturer offering one or more discounts.

However, these discounts are directed to single ingredient drugs, are performed at the network switch level, and are not applicable to compounded drugs or pharmaceuticals; neither are they related to anything other than the drug that was prescribed and is being considered for an available discount. U.S. patent application Ser. No. 15/144,260 entitled “Systems and Methods for Providing Consumer Discounts on Compounded Prescription Medications,” the content of which is hereby incorporated by reference in its entirety, is directed to providing consumer discounts for compounded prescription drugs and medications. There are other processes in the marketplace, but they do not function in this described fashion for claim requests that are not sent to the primary payer.

### SUMMARY

Embodiments of the present invention address and overcome one or more of the above shortcomings and drawbacks by providing methods, systems, and apparatuses related to providing customized consumer discounts on prescription medications. Briefly, according to some embodiments provided herein, prior transactions that have been honored for discounts are considered as part of a decision process for determining future discounts for the same or different products. The future discounts that are provided may have different values based on certain data contents of the prior transaction as it compares to a future transaction. Additionally, according to embodiments provided herein, multiple suppliers of the same product are enabled to have different discount designs and provide those discounts to those transactions that occur within a certain set of providers of the product to the consumers.

According to some embodiments, a computer-implemented method of providing a discount to a consumer purchasing a medication from a pharmacy includes receiving, by a discount payer adjudication engine, a new benefit claim from a pharmacy computer comprising (i) a member identifier corresponding to a member and (ii) an indication of medication. The discount payer adjudication engine determines whether the member is eligible for the new benefit claim at least in part based on one or more previously approved benefit claims associated with the member. If the member is eligible for the new benefit claim, an approved claim response is transmitted to the pharmacy computer. If the member is not eligible for the new benefit claim, a denied claim response is transmitted to the pharmacy computer.

Various enhancements, refinements, and other modifications can be made in different embodiments of the present invention. For example, previously approved benefit claims may each include a claim related to the same medication as the medication in the new benefit claim. Alternatively, the previously approved benefit claims may each include a claim related to a different medication than the medication in the new benefit claim. In one embodiment, the member is only determined to be eligible for the new benefit claim if the previously approved benefit claims associated with the member were approved within a predetermined time period prior to receiving the new benefit claim.

In some embodiments of the aforementioned method, eligibility of the member for the new benefit claim is further determined based on a comparison of demographic information corresponding to the consumer and demographic requirements associated with the new benefit claim. For example, in one embodiment, the demographic information comprises the consumer's age and the demographic requirements associated with the new benefit claim specify an age range. In another embodiment, the demographic information comprise a zip code corresponding to the consumer's residence and the demographic requirements associated with the new benefit claim specify a list of zip codes.

According to other embodiments, a computer-implemented method of providing a discount to a consumer purchasing a medication from a pharmacy includes a discount payer adjudication engine receiving a new benefit claim from a pharmacy computer comprising (i) a member identifier corresponding to a member and (ii) an indication of the medication. The discount payer adjudication engine determines whether the member is eligible for the new benefit claim at least in part based on (i) one or more previously approved benefit claims corresponding to the medication submitted on behalf of the member and on (ii) one or more previously approved benefit claims corresponding to a related medication submitted on behalf of the member. If the member is eligible for the new benefit claim, an approved claim response is transmitted to the pharmacy computer. If the member is not eligible for the new benefit claim, a denied claim response is transmitted to the pharmacy computer.

According to other embodiments, a computer-implemented method of providing a discount to a consumer purchasing a medication from a pharmacy includes a discount payer adjudication engine receiving a new benefit claim from a pharmacy computer comprising (i) a member identifier corresponding to a member and (ii) an indication of medication. The discount payer adjudication engine determines (i) whether the member is eligible for the benefits program using the member identifier; (ii) whether the medication is eligible for a benefits program; and (iii) whether a previously submitted benefit claim for another medication has been approved by the discount payer adjudication engine within a specified time period prior to receiving the new benefit claim for the medication. An approved claim response is transmitted to the pharmacy computer if (i) the member is eligible for benefits; (ii) the medication is eligible for the benefits program; and (iii) the previously submitted benefit claim for another medication has been approved by the discount payer adjudication engine within the specified time period. A denied claim response is transmitted to the pharmacy computer if (i) the member is ineligible for benefits; (ii) the medication is ineligible for the benefits program; or (iii) the previously submitted benefit claim for another medication has not been approved by the discount payer adjudication engine within the specified time period.

According to other embodiments, a computer-implemented method of providing a discount to a consumer based on benefits previously approved for the member includes a discount payer adjudication engine receiving a new benefit claim from a pharmacy computer comprising (i) a consumer identifier corresponding to the consumer and (ii) an indication of the first medication. The discount payer adjudication engine retrieves a benefit record corresponding to the consumer based on the consumer identifier. This benefit record comprises indications of all benefits previously approved for the consumer. The discount payer adjudication engine transmits an approved claim response to the pharmacy computer indicating approval of the new benefit claim if (i) the benefit record indicates that the consumer received a prior approved benefit for the first medication, (ii) the benefit record indicates that the consumer received a prior approved benefit for a second medication, and (iii) the benefit record indicates that the consumer received a subsequent approved benefit for the second medication within a range of tolerance of the days' supply of medication approved on the prior approved benefit for the second medication. Conversely, the discount payer adjudication engine transmits a denied claim response to the pharmacy computer indicating denial of the new benefit claim if (i) the benefit record does not indicate that the consumer received a prior approved benefit for the first medication, (ii) the benefit record does not indicate that the consumer received a prior approved benefit for the second medication, or (iii) the benefit record does not indicate that the consumer received a subsequent approved benefit for the second medication within an acceptable range of tolerance of the days' supply of medication approved on the prior approved benefit for the second medication.

Additional features and advantages of the invention will be made apparent from the following detailed description of illustrative embodiments that proceeds with reference to the accompanying drawings.

### BRIEF DESCRIPTION OF THE FIGURES

The foregoing and other aspects of the present invention are best understood from the following detailed description when read in connection with the accompanying drawings. For the purpose of illustrating the invention, there are shown in the drawing exemplary embodiments that are presently preferred, it being understood, however, that the invention is not limited to the specific instrumentalities disclosed. Included in the drawings are the following Figures:

FIG. 1 depicts a block diagram of an illustrative system for offering and providing one or more discounts to a consumer, according to an embodiment.

FIG. 2-A depicts a sample processes for determining current availability, eligibility, and/or level of benefits for submitted claims, according to some embodiments, following a first claim for a particular drug (“Drug A”);

FIG. 2-B depicts a sample processes for determining current availability, eligibility, and/or level of benefits for submitted claims, according to some embodiments, following a first claim for another drug (“Drug B”);

FIG. 2-C depicts a sample processes for determining current availability, eligibility, and/or level of benefits for submitted claims, according to some embodiments, following a second claim for Drug A;

FIG. 2-D depicts a sample processes for determining current availability, eligibility, and/or level of benefits for submitted claims, according to some embodiments, following a second claim for Drug B;

FIG. 3 shows a decision tree for processing a first claim for Drug A to a discount payer, according to some embodiments;

FIG. 4 shows a decision tree for processing a first claim for Drug B to a discount payer, according to some embodiments;

FIG. 5 shows a decision tree for processing a second claim for Drug A to a discount payer, according to some embodiments;

FIG. 6 shows a decision tree for processing a second claim for Drug B to a discount payer, according to some embodiments;

FIG. 7 depicts a block diagram of illustrative internal hardware that may be used to contain or implement program instructions, according to various embodiments.

### DETAILED DESCRIPTION

The present disclosure relates generally to systems and methods for determining eligibility for and, if eligible, providing a discount to a consumer purchasing a medication from a pharmacy or other similar retailer, whether it be a compounded or commercially prepared medication. As used herein, a compound or compounded drug refers to a drug containing two or more unique and distinct ingredients.

Existing pharmaceutical discount plans are directed to single ingredient drugs as previously existing standards were directed to claims and discount processing for a single ingredient drug and only considered that specific drug and the demographics of the pharmacy or consumer for eligibility requirements. Moreover, prior discount transactions for drug product(s) that are different from the product being requested were not considered for determining future discount availability and level of benefit on the same or different compounded or single ingredient drugs.

With recent standards changes, such as National Council for Prescription Drug Programs (NCPDP) standard D.0, compounded drugs can be accurately reflected in claim processing. Prior to the D.0 standard, when billing for a compound, a pharmacy would enter each ingredient in the compound into the claim processing software, but the then-existing standard (3.X) did not support transmission of all compound element information. Rather, the then-existing standard only supported transmission of a single data element representing a product segment. Such an arrangement worked for non-compounded drugs, but did not provide a means for a pharmacy to claim individual ingredients contained within compounded drugs. Therefore, those ingredients that were included in the compounded medication, but not present in the electronic filing, could not be considered for discount availability. In addition to the standards' change enabling consideration of each ingredient of a compounded medication, according to embodiments provided herein, data (including the identity of the drug, time lapse between fills of the same or one or more different drug(s), “dispense-as-written” specification, and the identity, demographics, and/or geographic location of the consumer or pharmacy) is considered for eligibility qualification for the consumer discount.

The present disclosure utilizes information related to the consumer (e.g., demographics), product, time, provider, disease state, provider identity, prescriber details, prescription details (whether electronically or hard copy originated) and other tracking capabilities for claims transactions that occur after the primary transaction has been approved, as a trigger for a subsequent determination of benefit availability, eligibility, and/or level of benefit. This subsequent benefit may be patient centric and provided by one or more benefit sponsors based on rulesets that are determined prior to the availability, eligibility, and level of benefits determination.

The processes and techniques as described herein may be applied to the pharmaceutical industry to: a) increase consumer loyalty to a particular pharmacy (e.g., a pharmacy that participates in the discount program and provides maximized discounts to its patrons as compared to one that does not participate or has limited participation and may provide limited or no discounts to its patrons), b) increase consumer adherence for the appropriate duration of therapy prescribed as well as compliance to one or more drug therapies as prescribed, c) stimulate brand loyalty to the sponsor of the benefit when the consumer has an opportunity for future use of additional products offered by that sponsor. For example, a pharmaceutical company (sponsor) may wish to provide a cost-reduction benefit to consumers whose prescriber has prescribed one of the sponsor's products. The benefit offer may be available, limited or maximized, to those claim requests which meet one or more of the following requirements: a) patient must be female, b) patient must be between the ages of 40 and 60 years old, c) patient must live within a specific set of zip codes (e.g., 71291, 71292, 71294, 71201, 71202, 71203), d) patient must have a specified disease state (e.g., 016.1 for Unspecified maternal hypertension, first trimester), e) patient must have received a prescription within the prior thirty (30) days for the same or a different specified product from that sponsor or another sponsor, f) prescriber mandates no product substitution (i.e., Dispense as Written code of 01), g) provider sending benefit claim request has one or more characteristics that determine availability or level of benefits (i.e., member of a defined group of “preferred” providers, located within a specified geography, or within a specific provider category on a national database (whether public or private)).

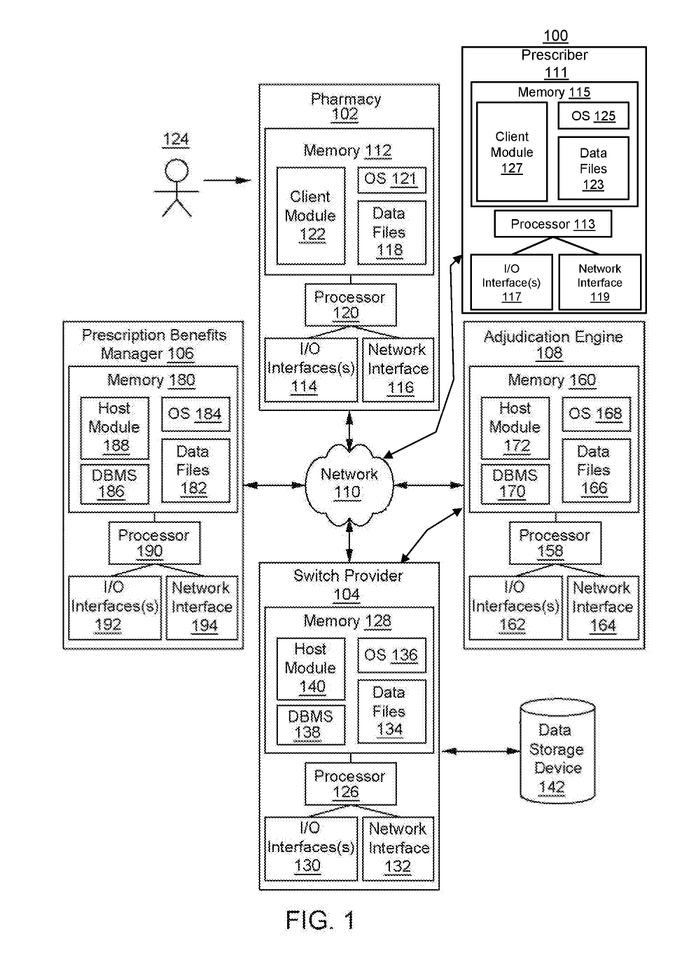

FIG. 1 illustrates an exemplary system 100 that allows a benefit sponsor to retain or shift its drug market share in the 100% co-pay marketplace (e.g., a discount program) and the funded (e.g., insurance plan, retirement benefits plan, etc.) marketplace. In particular, the system 100 includes a user 124, at least one pharmacy computer 102, at least one switch provider 104, a pharmaceutical (or prescription) benefits manager (PBM) 106, and an adjudication engine 108, which are each configured for accessing and reading associated computer-readable media having stored thereon data and/or computer-executable instructions for implementing the various methods of the invention. Generally, the adjudication engine 108 may determine benefits, coverage, and/or extent of coverage for one or more claims. According to one embodiment of the invention, the adjudication engine 108 may be associated with a pharmaceutical benefits manager (PBM), such as the PBM 106, which may generally include any third-party payer such as insurance companies, a retirement benefits plan, and the like. According to another embodiment of the invention, the adjudication engine 108 may also include sponsors or providers of 100% co-pay plans such as discount programs. According to yet another embodiment of the invention, the adjudication engine 108 may be the switch provider or located within the switch provider 104.

Generally, network devices and systems, including the one or more pharmacy computers 102, switch providers 104, PBMs 106, and adjudication engines 108 have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” describes any form of non-transitory memory or a propagated signal transmission medium. Propagated signals representing data and computer-executable instructions are transferred between network devices and systems.

Still referring to FIG. 1, a pharmacy computer 102 may be in communication with the switch provider 104 via a network 110, which as described below can include one or more private and public networks, including the Internet. Likewise, the switch provider 104 may also be in communication with an adjudication engine 108 via the network 110 and with a PBM 106 via the network 110. According to an embodiment of the invention, the pharmacy computer 102, the switch provider 104, and the adjudication engine 108 may be in direct communication with each other. According to an embodiment of the invention, the prescriber computer 111, the pharmacy computer 102, the switch provider 104, the adjudication engine 108, and the PBM 106 may be in direct communication with each other. Each of these components—the pharmacy computer 102, the switch provider 104, the PBM 106, the adjudication engine 108, the prescriber computer 111, and the network 110—will now be discussed in turn below.

First, the pharmacy computer 102 may be any processor-driven device, such as a personal computer, laptop computer, handheld computer, and the like. In addition to having a processor 120, the pharmacy computer 102 may further include a memory 112, input/output (“I/O”) interface(s) 114, and a network interface 116. The memory 112 may store data files 118 and various program modules, such as an operating system (“OS”) 121 and a client module 122. The client module 122 may be an Internet browser or other software, including a dedicated program, for interacting with the switch provider 104. For example, a user such as a pharmacist or other pharmacy employee may utilize the client module 122 in preparing and providing a drug request or order to the switch provider 104 for processing. The pharmacy computer 102 may also utilize the client module 122 to retrieve or otherwise receive data from the switch provider 104, including application or availability of a voucher, coupon, payment and/or discount, as described herein, for the drug request or order.

Still referring to the pharmacy computer 102, the I/O interface(s) 114 facilitate communication between the processor 120 and various I/O devices, such as a keyboard, mouse, printer, microphone, speaker, monitor, bar code readers/scanners, RFID readers, and the like. The network interface 116 may take any of a number of forms, such as a network interface card, a modem, a wireless network card, and the like. These and other components of the pharmacy computer 102 will be apparent to those of ordinary skill in the art and are therefore not discussed in more detail herein.

Similar to the pharmacy computer 102, the switch provider 104 may include any processor-driven device that is configured for receiving, processing, and fulfilling requests or claims from the pharmacy computer 102 related to pharmacy, benefits, and/or discount transactions, including coupons and/or vouchers described herein. The switch provider 104 may therefore include a processor 126, a memory 128, input/output (“I/O”) interface(s) 130, and a network interface 132. The memory 128 may store data files 134 and various program modules, such as an operating system (“OS”) 136, a database management system (“DBMS”) 138, and the host module 140. According to an embodiment of the invention, the data files 134 may store history records or tables associated with one or more claim submissions. The data files 134 may also store routing tables for determining the subsequent transmission of received claim submission. For example, these routing tables may determine that particular claim submissions are associated with certain PBMs, and therefore specify a particular adjudication engine 108 to route the claim submissions to. The host module 140 initiates, receives, processes, and responds to requests from the respective client module 122 of pharmacy computer 102, and further initiates, receives, processes, and responds to requests from the respective host modules 172 of the adjudication engine 108. The switch provider 104 may include additional program modules for performing other pre-processing or post-processing methods described herein. Those of ordinary skill in the art will appreciate that the switch provider 104 may include alternate and/or additional components, hardware, or software. According to an embodiment of the invention, the switch provider 104 may be similar to the host server described in U.S. patent application Ser. No. 10/439,422, filed May 16, 2003, and entitled “Systems and methods for verifying and editing electronically transmitted claim content.” The foregoing application, which was published on Apr. 22, 2004 as U.S. Patent Publication No. 2004/0078247, is incorporated herein by reference in its entirety.

As illustrated in FIG. 1, the switch provider 104 may include or be in communication with at least one data storage device 142, or databases. If the switch provider 104 includes the data storage device 142, then the data storage device 142 could also be part of the memory 128. The data storage device 142 and/or memory 128 may store, for example, program rules and transaction records (e.g., demographic requirements for benefits programs, history records) and/or discounts (e.g., coupons, vouchers, etc.) associated with the drug requests and orders. Although a single data storage device 142 is referred to herein for simplicity, those skilled in the art will appreciate that multiple physical and/or logical data storage devices or databases may be used to store the abovementioned data. For security and performance purposes, the switch provider 104 may have a dedicated connection to the data storage device 142. However, the switch provider 104 may also communicate with the data storage device 142 via a network 110, as shown. In other embodiments of the invention, the switch provider 104 may include the data storage device 142 locally. The switch provider 104 may also otherwise be part of a distributed or redundant database management system (“DBMS”).

The PBM 106 may include any processor-driven device that is configured for receiving, processing, and fulfilling requests from the switch provider 104 related to the pharmacy, benefits, and/or discount transactions, including coupons and/or vouchers described herein. The PBM 106 may therefore include a processor 190, a memory 180, input/output (“I/O”) interface(s) 192, and a network interface 194. The memory 180 may store data files 182 and various program modules, such as an operating system (“OS”) 184, a database management system (“DBMS”) 186, and a host module 188. The host module 188 may initiate, receive, process, and respond to requests from host module 140 of the switch provider 104. The PBM 106 may include additional program modules for performing other pre-processing or post-processing methods described herein. Those of ordinary skill in the art will appreciate that the PBM 106 may include alternate and/or additional components, hardware or software.

Similarly, the adjudication engine 108 may include any processor-driven device that is configured for receiving, processing, and fulfilling requests from the switch provider 104 related to the pharmacy, benefits, and/or discount transactions. The adjudication engine 108 may therefore include a processor 158, a memory 160, input/output (“I/O”) interface(s) 162, and a network interface 164. The memory 160 may store data files 166 and various program modules, such as an operating system (“OS”) 168, a database management system (“DBMS”) 170, and the host module 172. The host module 172 may initiate, receive, process, and respond to requests from host module 140 of the switch provider 104. The adjudication engine 108 may include additional program modules for performing other preprocessing or post-processing methods described herein. Those of ordinary skill in the art will appreciate that the adjudication engine 108 may include alternate and/or additional components, hardware, or software.

First, the prescriber computer 111 may be any processor-driven device, such as a personal computer, laptop computer, handheld computer, and the like. In addition to having a processor 113, the prescriber computer 111 may further include a memory 115, input/output (“I/O”) interface(s) 117, and a network interface 119. The memory 115 may store data files 123 and various program modules, such as an operating system (“OS”) 125 and a client module 127. The client module 127 may be an Internet browser or other software, including a dedicated program, for interacting with the switch provider 104. For example, a user such as a pharmacist or other pharmacy employee may utilize the client module 127 in preparing and providing a drug request or order to the switch provider 104 for processing. The prescriber computer 111 may also utilize the client module 127 to retrieve or otherwise receive data from the switch provider 104, including application or availability of a voucher, coupon, payment and/or discount, as described herein, for the drug request or order.

Still referring to the prescriber computer 111, the I/O interface(s) 117 facilitate communication between the processor 113 and various I/O devices, such as a keyboard, mouse, printer, microphone, speaker, monitor, bar code readers/scanners, RFID readers, and the like. The network interface 119 may take any of a number of forms, such as a network interface card, a modem, a wireless network card, and the like. These and other components of the prescriber computer 111 will be apparent to those of ordinary skill in the art and are therefore not discussed in more detail herein.

The network 110 may include any telecommunication and/or data network, whether public, private, or a combination thereof, including a local area network, a wide area network, an intranet, an internet, the Internet, intermediate hand-held data transfer devices, and/or any combination thereof and may be wired and/or wireless. The network 110 may also allow for real-time, off-line, and/or batch transactions to be transmitted between the pharmacy computer 102 and the switch provider 104. Due to network connectivity, various methodologies as described herein may be practiced in the context of distributed computing environments.

Although the pharmacy computer 102 is shown for simplicity as being in communication with the switch provider 104 via one intervening network 110, it is to be understood that any other network configuration is possible. For example, intervening network 110 may include a plurality of networks, each with devices such as gateways and routers for providing connectivity between or among networks 110. Instead of or in addition to a network 110, dedicated communication links may be used to connect the various devices of the invention. According to an embodiment of the invention, the network 110 may include a network similar to NDCHealth's Intelligent Network.

Those of ordinary skill in the art will appreciate that the system 100 shown in and described with respect to FIG. 1 is provided by way of example only. Numerous other operating environments, system architectures, and device configurations are possible. Accordingly, the invention should not be construed as being limited to any particular operating environment, system architecture, or device configuration.

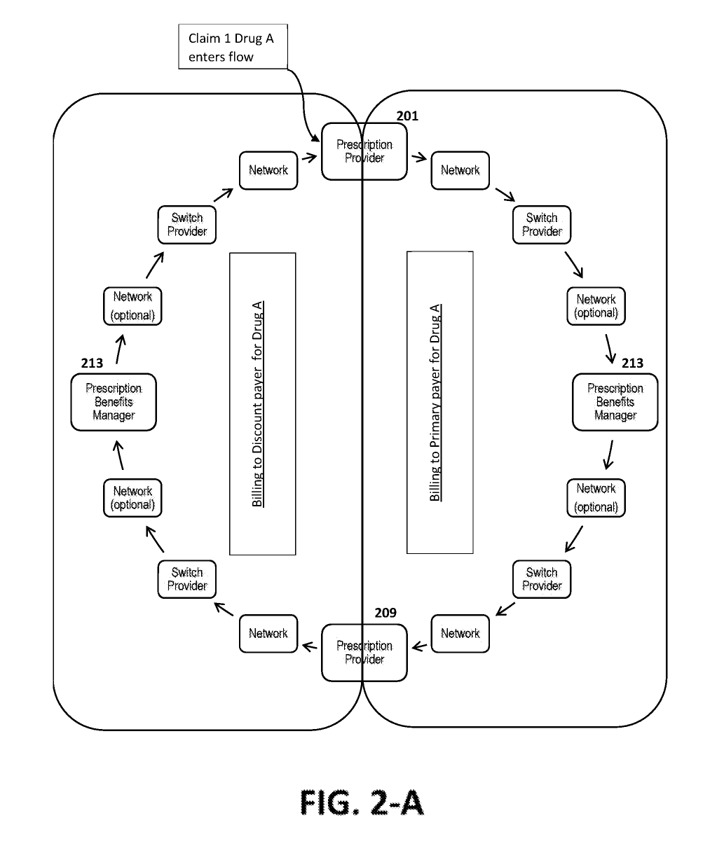

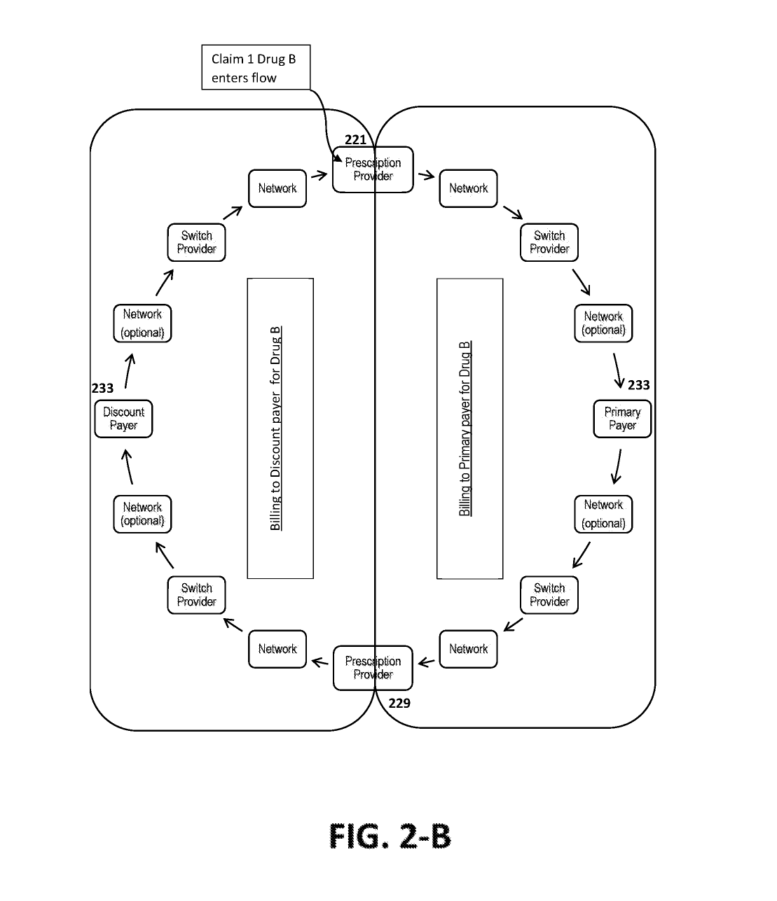

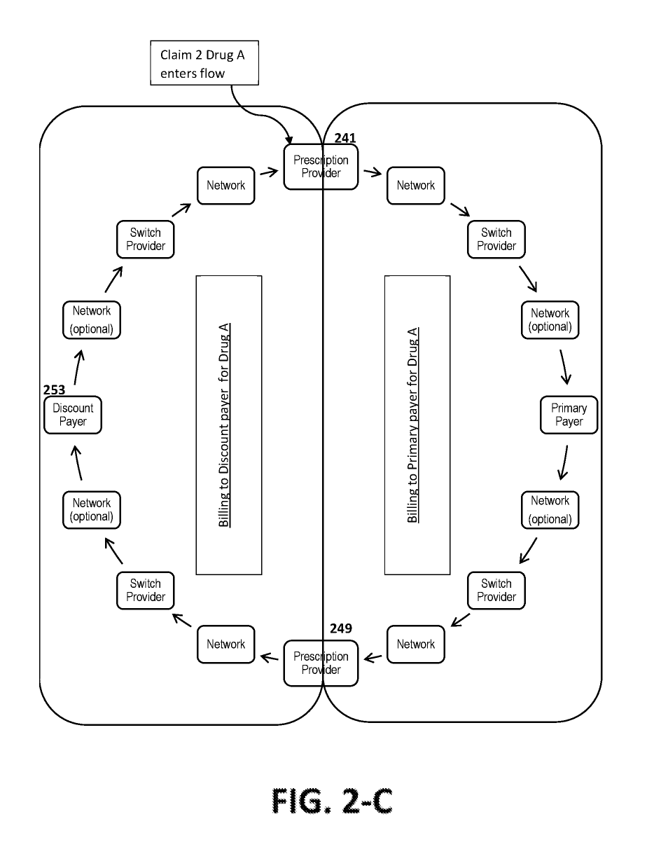

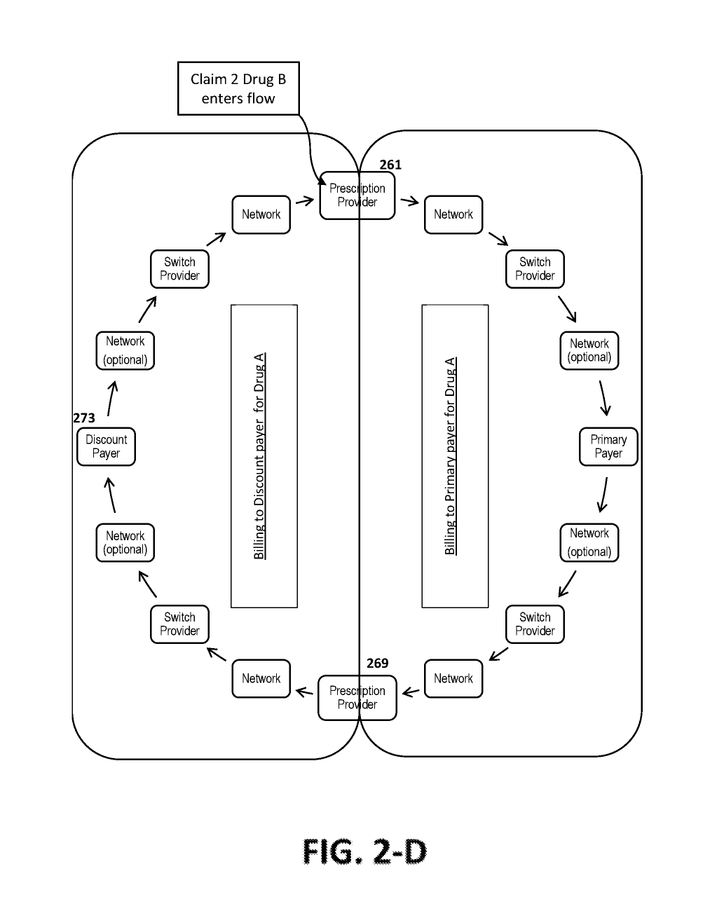

As discussed above with respect to FIG. 1, embodiments assist benefits sponsor(s) in retaining or shifting market share for particular drugs. The operation of embodiments of the invention will now be described below with reference to FIGS. 2-A through 2-D. FIGS. 2-A through FIG. 2-D illustrate conjoining circle process flows that are each exclusive processes. However, subsequent flow processes, such as those represented in FIGS. 2-B through 2-D, may be reliant on data generated by preceding flow processes and stored in the data storage device 142 to determine outcome of the current flow process. For example, in FIG. 2-B, a consumer may obtain a discount that is generated in FIG. 2-A for which the data is stored in the data storage device 142. Subsequent to FIG. 2-A, a provider presents a benefits claim inquiry for the same consumer (FIG. 2-B), but a different drug. The process flow in FIG. 2-B may use data elements generated by the benefits claim in FIG. 2-A and stored in the data storage device 142 to determine availability, eligibility, and/or level of benefit. One embodiment illustrated in FIG. 2-B provides benefit eligibility for claim 1 Drug B only if claim 1 Drug A was successfully and completely adjudicated.

As discussed above with respect to FIG. 2-B, further embodiments may use data that is generated by process flows that occurred prior to the current process flow (whether in FIG. 2-C, FIG. 2-D, or some continuing process flow as it relates to conditional availability, eligibility, and/or level of benefits) stored in the data storage device 142 and used to determine current availability, eligibility, and/or level of benefits. In FIG. 2-C, data in the data storage device 142 documents approved benefits for current consumer having received Drug A and/or Drug B on some date prior to current process shown in FIG. 2-C. Provider now presents, on consumer's behalf, a claim for potential benefits for Drug A. In the second half of the process flow, as it relates to “Billing to Discount payer for Drug A,” the data submitted on the claim and the data stored in the data storage device 142 is checked to determine availability, eligibility, and/or level of benefits.

In one embodiment of FIG. 2-C, benefits may only be available or be available in different amounts if the data stored in the data storage device 142 describes an approved claim for benefits for claim 1 Drug A that occurred within a specified time prior to the current submission for benefits. If the current submission does not occur within the specified time after the prior submission for claim 1 Drug A, benefits may not be available or may be available at a different rate than if it did occur within the specified time period.

In another embodiment of FIG. 2-C, benefits may only be available or be available in different amounts for the submission of claim 2 Drug A if the data stored in the data storage device 142 describes an approved claim for benefits for claim 1 Drug A or claim 1 Drug B that occurred within a specified time prior to the current submission for benefits shown for claim 2 Drug A.

If the current submission does not occur within the specified time after the prior submission for claim 1 Drug A or claim 1 Drug B, benefits may not be available or may be available at a different rate than if it did occur within the specified time period. In the embodiment shown in FIG. 2-D, benefits may only be available or be available in different amounts for claim 2 Drug B if the data stored in the data storage device 142 describes an approved claim for benefits for claim 1 Drug A, claim 1 Drug B, or claim 2 Drug A, that occurred within a specified time prior to the current submission for benefits. If the current submission for claim 2 Drug B does not occur within the specified time after the prior submission for claim 1 Drug A, claim 1 Drug B, or claim 2 Drug A, benefits may not be available or may be available at a different rate than if it did occur within the specified time period. It should be noted, however, that the processes as illustrated in FIGS. 2-A through 2-D, and described herein, are shown by way of example only and may be altered based upon implementation of the consumer discount system and method as described herein. Similarly, the processes as shown in FIGS. 2-A through 2-D may be altered as a result of changes to industry standards, as applicable, and are meant only for illustrative and discussion purposes.

It should be understood that the offer for benefits can be made by pre-qualifying the drug, patient, provider, and prescriber by utilizing the data stored in the data storage device 142 and the rule sets contained in the adjudication engine 108, then making the offer available by activating and sending benefits notification to the prescriber computer 111 prior to the prescriber presenting the prescription for the product to the pharmacy or other provider of the product to the consumer. The pharmacy or other provider may or may not have to then follow the steps in one of the flow processes described in FIGS. 2-A through 2-D for benefits to be provided to consumer.

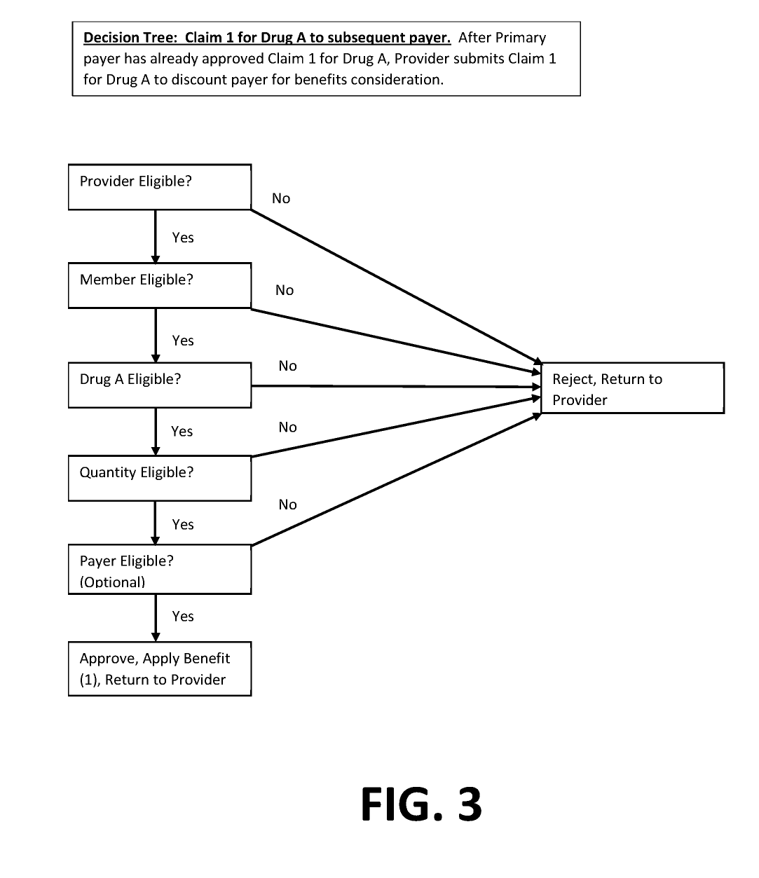

FIGS. 3 through 6 illustrate examples of the decision process that is followed to determine eligibility, availability, and level of benefits for the claim(s) that are submitted for consideration by the provider(s) represented in FIGS. 2-B through 2-D.

Now describing FIG. 3, claim 1 for Drug A has been submitted from the prescription provider 209 to the discount payer adjudication engine 108 of the discount payer 213 as shown in FIGS. 1 and 2-A. The discount payer adjudication engine 108 considers information that is contained in the electronic form on the claim submitted, information from the electronic forms stored in the data storage device 142, and data from provider, payer, prescriber, product, and consumer lists in the data files storage 166 contained within the discount payer adjudication engine 108. If the outcome of the eligibility and level of benefit interrogation results in a benefit being made available for the claim submitted, an approved claim response is returned to the prescription provider 201, and the benefit is provided to the consumer. If the outcome of the eligibility and level of benefit interrogation results in no benefit being made available for the claim submitted, a denied claim response is returned to the prescription provider 201, and no benefit is provided to the consumer.

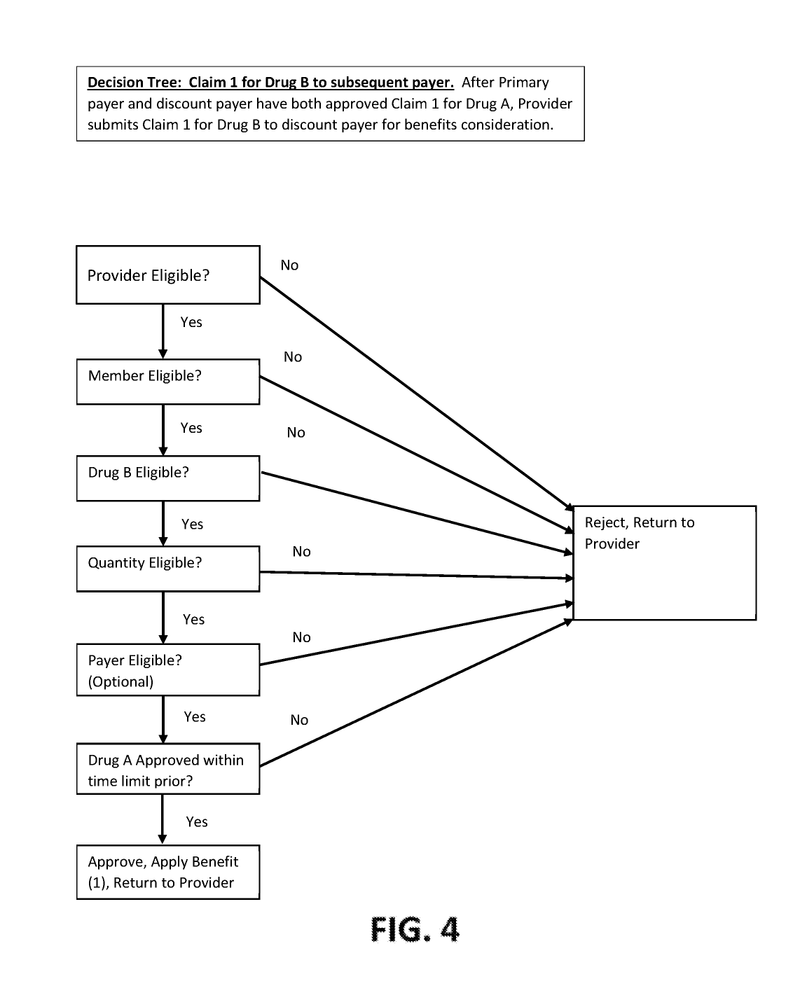

Now describing FIG. 4, claim 1 for Drug B has been submitted from the prescription provider 229 to the discount payer adjudication engine 108 of the discount payer 233 as shown in FIGS. 1 and 2-B. The discount payer adjudication engine 108 considers information that is contained in the electronic form on the claim submitted, information from the electronic forms stored in the data storage device 142, and data from provider, payer, prescriber, product, and consumer lists in the data files storage 166 contained within the discount payer adjudication engine 108. If the outcome of the eligibility and level of benefit interrogation results in a benefit being made available for the claim submitted, an approved claim response is returned to the prescription provider 221, and the benefit is provided to the consumer. If the outcome of the eligibility and level of benefit interrogation results in no benefit being made available for the claim submitted, a denied claim response is returned to the prescription provider 221, and no benefit is provided to the consumer.

One of the differences between FIG. 3 and FIG. 4 is that FIG. 4 adds an additional interrogatory referring to the presence of an approved benefit claim for Drug A within a specified time period prior to the benefits request for claim 1 for Drug B being submitted. This makes determination of eligibility and level of benefit availability for claim 1 Drug B reliant on the presence of an approved claim for a different product than what is being submitted on the claim 1 Drug B benefits request. One example of this in action is as follows: Sponsor wishes to provide discount benefits to eligible members using eligible prescribers for a gout medication that is used to relieve pain symptoms of an acute gout episode (Drug A) which is being dispensed to consumers at an eligible provider. In addition, the sponsor also wishes to provide discount benefits to eligible members using eligible prescribers for a gout medication that is used chronically to prevent acute gout episodes from occurring (Drug B) which is being dispensed to consumers at an eligible provider if they have previously received discount benefits for Drug A within a specified time period prior to the benefits claim submission for Drug B. The claim for discount benefits for Drug A does not have the requirement of a previously approved claim for other drugs. However, in order for the claim for discount benefits to be awarded for Drug B, the consumer must have previously, within a specified time period, received an approved benefits claim for Drug A.

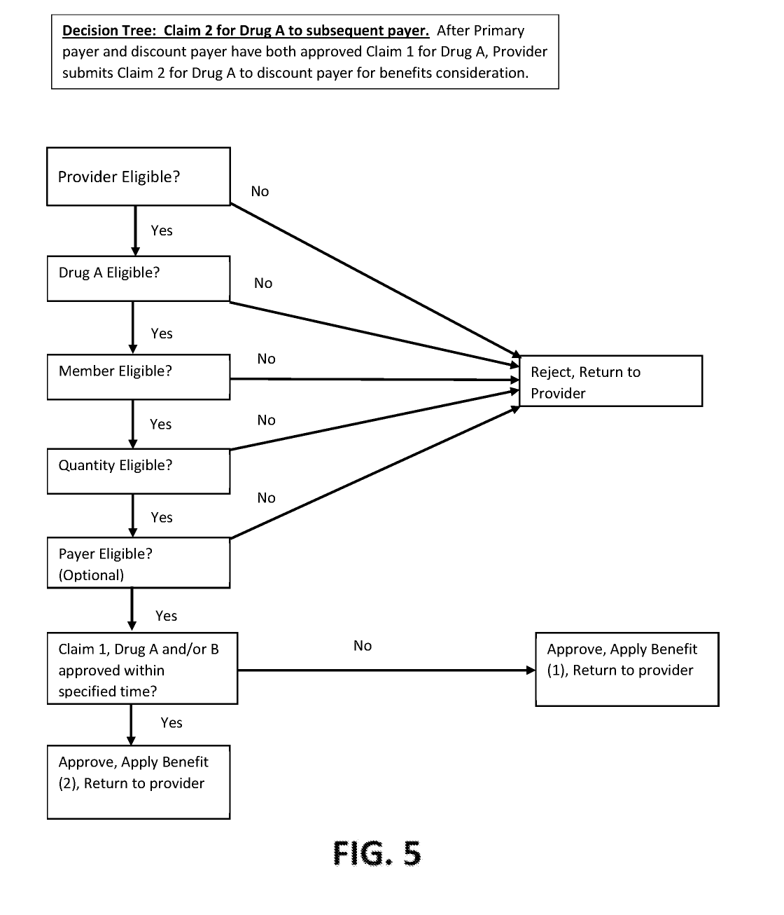

Now describing FIG. 5, claim 2 for Drug A has been submitted from the prescription provider 249 to the discount payer adjudication engine 108 of the discount payer 253 as shown in FIGS. 1 and 2-C. The discount payer adjudication engine 108 considers information that is contained in the electronic form on the claim submitted, information from the electronic forms stored in the data storage device 142, and data from provider, payer, prescriber, product, and consumer lists in the data files storage 166 contained within the discount payer adjudication engine 108. If the outcome of the eligibility and level of benefit interrogation results in a benefit being made available for the claim submitted, an approved claim response is returned to the prescription provider 241 and the benefit is provided to the consumer. If the outcome of the eligibility and level of benefit interrogation results in no benefit being made available for the claim submitted, a denied claim response is returned to the prescription provider 241, and no benefit is provided to the consumer.

One of the differences between FIG. 4 and FIG. 5 is that FIG. 5 adds an additional interrogatory referring to the presence of an approved benefit claim for Drug A (and may also add an interrogatory referring to the presence of an approved benefit claim for Drug B) within a specified time period prior to the benefits request for claim 2 for Drug A being submitted. This makes determination of eligibility and level of benefit availability for claim 2 Drug A reliant on the presence of an approved claim for the same (or an additional, different) product than what is being submitted on the claim 2 Drug A benefits request. One example of this in action is as follows: Sponsor wishes to provide discount benefits to eligible members using eligible prescribers for a gout medication that is used to relieve pain symptoms of an acute gout episode (Drug A) which is being dispensed to consumers at an eligible provider.

However, the sponsor wants the consumer to continue the therapy as prescribed and have healthier outcomes as a result of using the product properly. Therefore, on claim 1 for Drug A, a benefit of $10 may be made available to the consumer and on claim 1 for Drug B, a benefit of $10 may be made available. However, on claim 2 for Drug A, a benefit of $20 may be made available to the consumer with the presence of a prior, approved benefit for both Drug A and Drug B on prior claims within an acceptable range of tolerance of the days' supply of medication approved on the prior benefits. This additional benefit for claim 2 Drug A is in case the medication to prevent the acute gout flare, Drug B, is not sufficient to prevent future acute episodes.

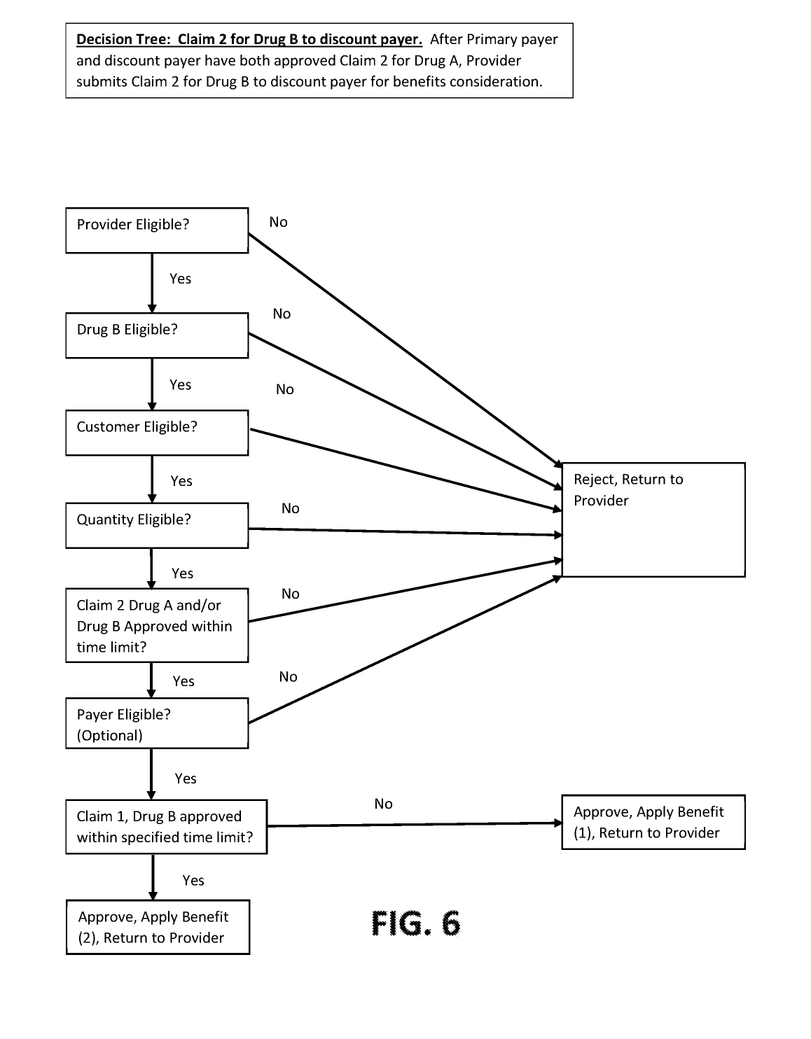

Now describing FIG. 6, claim 2 for Drug B has been submitted from the prescription provider 269 to the discount payer adjudication engine 108 of the discount payer 273 as shown in FIGS. 1 and 2-D. The discount payer adjudication engine 108 considers information that is contained in the electronic form on the claim submitted, information from the electronic forms stored in the data storage device 142, and data from provider, payer, prescriber, product, and consumer lists in the data files storage 166 contained within the discount payer adjudication engine 108. If the outcome of the eligibility and level of benefit interrogation results in a benefit being made available for the claim submitted, an approved claim response is returned to the prescription provider 261, and the benefit is provided to the consumer. If the outcome of the eligibility and level of benefit interrogation results in no benefit being made available for the claim submitted, a denied claim response is returned to the prescription provider 261, and no benefit is provided to the consumer.

One of the differences between FIG. 5 and FIG. 6 is that FIG. 6 adds an additional interrogatory referring to the presence of an approved benefit claim for Drug B (and may also add an interrogatory referring to the presence of an approved benefit claim for Drug A) within a specified time period prior to the benefits request for claim 2 for Drug B being submitted. This makes determination of eligibility and level of benefit availability for claim 2 Drug B reliant on the presence of an approved claim for the same (or an additional different) product than what is being submitted on the claim 2 Drug B benefits request.

One example of this in action is as follows: Sponsor wishes to provide discount benefits to eligible members using eligible prescribers for a gout medication that is used to relieve pain symptoms of an acute gout episode (Drug A) which is being dispensed to consumers at an eligible provider and therapy to prevent acute gout episodes (Drug B). However, for some reason, the consumer's maintenance therapy (Drug B) failed to maintain control of the gout condition and a subsequent acute gout episode occurred. The sponsor wants the consumer to achieve healthier outcomes as a result of using the proper product in the correct dosage amount. Therefore, a benefit of $10 may be made available to the consumer on claim 1 for Drug A, a benefit of $10 may be made available on claim 1 for Drug B, and a benefit of $20 may be made available on claim 2 for Drug A. Then, on claim 2 for Drug B, a benefit of $25 may be made available to the consumer with the presence of a prior approved benefit for Drug A, a prior approved benefit for Drug B, and a subsequent approved benefit for Drug A within acceptable range of tolerance of the days' supply of medication approved on the prior benefits. This additional benefit for claim 2 Drug B is in case the medication to prevent the acute gout flare, Drug B, failed to prevent a second acute gout episode and the dosage of the same drug (Drug B) is altered to recover a non-episodic state. The second approved benefit for Drug A within a specified time period indicates a failure of the first treatment with Drug B, making the use of a second quantity of Drug A necessary.

It should not be construed that the invention is limited to the number or type of availability, eligibility and level of benefits determination shown in the figures or descriptions made in the examples. Rather, the pattern can continue for many levels of qualifying events.

One of the identifying characteristics of the invention is the use of logic that considers previous events of the same or different products in order to determine availability, eligibility, and/or level of benefits for benefit claims that are submitted AFTER the primary insurance claim has been approved by the primary payer.

The processes as shown in FIGS. 2-A through D and FIGS. 3-6 are described herein as various components of a single method or process. However, it should be noted that such a description is provided by way of example only. Various steps or process portions as described herein may be separated from the entire process and implemented singularly, reordered, or omitted entirely depending upon the implementation of the processes and techniques as described herein.

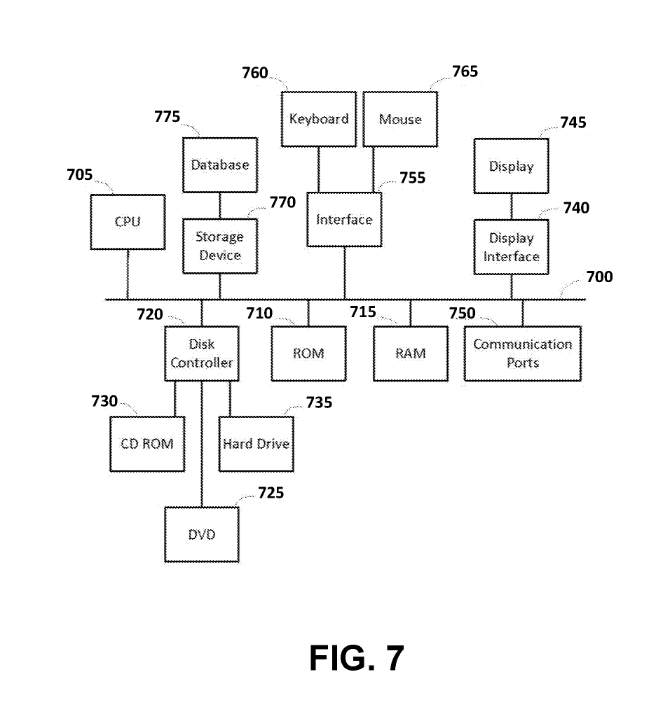

FIG. 7 depicts a block diagram of illustrative internal hardware that may be used to contain or implement program instructions, such as the process steps discussed herein, according to various embodiments. A bus 700 may serve as the main information highway interconnecting the other illustrated components of the hardware. A CPU 705 is the central processing unit of the system, performing calculations and logic operations required to execute a program. The CPU 705, alone or in conjunction with one or more of the other elements disclosed in FIG. 7, is an illustrative processing device, computing device or processing device as such terms are used within this disclosure. Read only memory (ROM) 710 and random access memory (RAM) 715 constitute illustrative memory devices (such as, for example, processing device-readable non-transitory storage media).

A controller 720 interfaces with one or more optional memory devices to the system bus 700. These memory devices may include, for example, an external or internal DVD drive 725, a CD ROM drive 730, a hard drive 735, flash memory, a USB drive, or the like. As indicated previously, these various drives and controllers are optional devices.

Program instructions, software, or interactive modules for providing the interface and performing any querying or analysis associated with one or more data sets may be stored in the ROM 710 and/or the RAM 715. Optionally, the program instructions may be stored on a tangible computer-readable medium such as a compact disk, a digital disk, flash memory, a memory card, a USB drive, an optical disc storage medium, such as a Blu-ray™ disc, and/or other non-transitory storage media.

An optional display interface 740 may permit information from the bus 700 to be displayed on the display 745 in audio, visual, graphic, or alphanumeric format, such as the interface previously described herein. Communication with external devices, such as a print device, may occur using various communication ports 750. An illustrative communication port 750 may be attached to a communications network, such as the Internet, an intranet, or the like.

The hardware may also include an interface 755 which allows for receipt of data from input devices such as a keyboard 760 or other input device 765 such as a mouse, a joystick, a touch screen, a remote control, a pointing device, a video input device, and/or an audio input device.

The hardware may also include a storage device 770 such as, for example, a connected storage device, a server, and an offsite remote storage device. Illustrative offsite remote storage devices may include hard disk drives, optical drives, tape drives, cloud storage drives, and/or the like. The storage device 770 may be configured to store data as described herein, which may optionally be stored on a database 775. The database 775 may be configured to store information in such a manner that it can be indexed and searched, as described herein. The computing device of FIG. 7 and/or components thereof may be used to carry out the various processes as described herein.

The above disclosure is not limited to the particular systems, devices and methods described, as these may vary. The terminology used in the description is for the purpose of describing the particular versions or embodiments only, and is not intended to limit the scope. The functions and process steps herein may be performed automatically or wholly or partially in response to user command. An activity (including a step) performed automatically is performed in response to one or more executable instructions or device operation without user direct initiation of the activity.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, modules, and processes can be implemented using hardware components, software components, and/or combinations thereof. No claim element herein is to be construed under the provisions of 35 U.S.C. 112(f) unless the element is expressly recited using the phrase “means for.”

We claim:

1. A computer-implemented method of providing a discount to a consumer purchasing a medication from a pharmacy, the method comprising:
receiving, by an discount payer adjudication engine, a new benefit claim from a pharmacy computer comprising (i) a member identifier corresponding to a member and (ii) an indication of medication;
determining, by the discount payer adjudication engine, whether the member is eligible for the new benefit claim at least in part based on one or more previously approved benefit claims associated with the member;
if the member is eligible for the new benefit claim, transmitting an approved claim response to the pharmacy computer; and
if the member is not eligible for the new benefit claim, transmitting a denied claim response to the pharmacy computer.

2. The method of claim 1, wherein the one or more previously approved benefit claims each include a claim related to the same medication as the medication in the new benefit claim.

3. The method of claim 1, wherein the one or more previously approved benefit claims each include a claim related to a different medication than the medication in the new benefit claim.

4. The method of claim 1, wherein the member is only determined to be eligible for the new benefit claim if the previously approved benefit claims associated with the member were approved within a predetermined time period prior to receiving the new benefit claim.

5. The method of claim 1, wherein eligibility of the member for the new benefit claim is further determined based on a comparison of demographic information corresponding to the consumer and demographic requirements associated with the new benefit claim.

6. The method of claim 5, wherein the demographic information comprises the consumer's age and the demographic requirements associated with the new benefit claim specify an age range.

7. The method of claim 5, wherein the demographic information comprise a zip code corresponding to the consumer's residence and the demographic requirements associated with the new benefit claim specify a list of zip codes.

8. A computer-implemented method of providing a discount to a consumer purchasing a medication from a pharmacy, the method comprising:
receiving, by a discount payer adjudication engine, a new benefit claim from a pharmacy computer comprising (i) a member identifier corresponding to a member and (ii) an indication of the medication;
determining, by the discount payer adjudication engine, whether the member is eligible for the new benefit claim at least in part based on (i) one or more previously approved benefit claims corresponding to the medication submitted on behalf of the member and on (ii) one or more previously approved benefit claims corresponding to a related medication submitted on behalf of the member;
if the member is eligible for the new benefit claim, transmitting an approved claim response to the pharmacy computer; and
if the member is not eligible for the new benefit claim, transmitting a denied claim response to the pharmacy computer.

9. The method of claim 8, wherein the member is only determined to be eligible for the new benefit claim if the one or more previously approved benefit claims corresponding to the medication were approved within a predetermined time period prior to receiving the new benefit claim.

10. The method of claim 8, wherein the member is only determined to be eligible for the new benefit claim if the one or more previously approved benefit claims corresponding to a related medication were approved within a predetermined time period prior to receiving the new benefit claim.

11. The method of claim 10, wherein the predetermined time period is based on the size of the supply of the related medication associated with the one or more previously approved benefit claims.

12. The method of claim 8, wherein eligibility of the member for the new benefit claim is further determined based on a comparison of demographic information corresponding to the consumer and demographic requirements associated with the new benefit claim.

13. The method of claim 12, wherein the demographic information comprises the consumer's age and the demographic requirements associated with the new benefit claim specify an age range.

14. The method of claim 12, wherein the demographic information comprise a zip code corresponding to the consumer's residence and the demographic requirements associated with the new benefit claim specify a list of zip codes.

15. A computer-implemented method of providing a discount to a consumer purchasing a medication from a pharmacy, the method comprising:
receiving, by a discount payer adjudication engine, a new benefit claim from a pharmacy computer comprising (i) a member identifier corresponding to a member and (ii) an indication of medication;
determining , by the discount payer adjudication engine, whether the member is eligible for the benefits program using the member identifier;
determining, by the discount payer adjudication engine, whether the medication is eligible for a benefits program;
determining, by the discount payer adjudication engine, whether a previously submitted benefit claim for another medication has been approved by the discount payer adjudication engine within a specified time period prior to receiving the new benefit claim for the medication;
transmitting, by the discount payer adjudication engine, an approved claim response to the pharmacy computer if (i) the member is eligible for benefits; (ii) the medication is eligible for the benefits program; and (iii) the previously submitted benefit claim for another medication has been approved by the discount payer adjudication engine within the specified time period; and
transmitting, by the discount payer adjudication engine, a denied claim response to the pharmacy computer if (i) the member is ineligible for benefits; (ii) the medication is ineligible for the benefits program; or (iii) the previously submitted benefit claim for another medication has not been approved by the discount payer adjudication engine within the specified time period.

16. A computer-implemented method of providing a discount to a consumer based on benefits previously approved for the member the method comprising:
receiving, by a discount payer adjudication engine, a new benefit claim from a pharmacy computer comprising (i) a consumer identifier corresponding to the consumer and (ii) an indication of the first medication;
retrieving a benefit record corresponding to the consumer based on the consumer identifier, wherein the benefit record comprises indications of all benefits previously approved for the consumer;
transmitting an approved claim response to the pharmacy computer indicating approval of the new benefit claim if (i) the benefit record indicates that the consumer received a prior approved benefit for the first medication, (ii) the benefit record indicates that the consumer received a prior approved benefit for a second medication, and (iii) the benefit record indicates that the consumer received a subsequent approved benefit for the second medication within a range of tolerance of the days' supply of medication approved on the prior approved benefit for the second medication; and
transmitting a denied claim response to the pharmacy computer indicating denial of the new benefit claim if (i) the benefit record does not indicate that the consumer received a prior approved benefit for the first medication, (ii) the benefit record does not indicate that the consumer received a prior approved benefit for the second medication, or (iii) the benefit record does not indicate that the consumer received a subsequent approved benefit for the second medication within an acceptable range of tolerance of the days' supply of medication approved on the prior approved benefit for the second medication.
